(19) United States
(12) Patent Application Publication
(10) Pub. No.: US 2026/0006664 A1
(43) Pub. Date: Jan. 1, 2026

(54) COMMUNICATION DEVICE, NON-TRANSITORY COMPUTER-READABLE RECORDING MEDIUM STORING COMPUTER-READABLE INSTRUCTIONS FOR COMMUNICATION DEVICE, AND METHOD EXECUTED BY COMMUNICATION DEVICE

(71) Applicant: BROTHER KOGYO KABUSHIKI KAISHA, Nagoya (JP)

(72) Inventor: Ryoya TSUJI, Nagoya (JP)

(21) Appl. No.: 19/250,205

(22) Filed: Jun. 26, 2025

(30) Foreign Application Priority Data
Jun. 28, 2024 (JP) 2024-105363

(51) Int. Cl. H04W 76/15; H04W 12/03; H04W 84/12

(52) U.S. Cl. CPC H04W 76/15; H04W 12/03; H04W 84/12

(57) ABSTRACT

A first communication may be configured to, in a case where first communication information for establishing a first wireless connection between the first communication device and a second communication device is obtained and fixed identification information of the second communication device is received from the second communication device, store, in the memory, the first communication information and the identification information in association with each other, and in a case where variable second communication information for establishing a second wireless connection between the first communication device and the second communication device is obtained and the identification information is received from the second communication device after the first wireless connection has been disconnected, delete, from the memory, the first communication information which is associated with the identification information and store, in the memory, the second communication information in association with the identification information.

### REFERENCE TO RELATED APPLICATIONS

This application claims priority from Japanese Patent Application No. 2024-105363 filed on Jun. 28, 2024. The entire content of the priority application is incorporated herein by reference.

### BACKGROUND ART

A known wireless communication device stores a connection ID of a mobile communication terminal with which connection was established with the wireless communication device in the past as a history, and uses this connection ID to determine which mobile communication terminal to be connected with. Such connection ID is deleted after a predetermined time elapses.

### SUMMARY

The present teachings provide a novel art configured to reduce a load on a memory of a first communication device.

A first communication device disclosed herein may include: a memory; and a controller, wherein the controller may be configured to: obtain variable first communication information for establishing a first wireless connection between the first communication device and a second communication device; receive fixed identification information of the second communication device from the second communication device; in a case where the first communication information is obtained and the identification information is received, store, in the memory, the first communication information and the identification information in association with each other; obtain variable second communication information for establishing a second wireless connection between the first communication device and the second communication device after the first wireless connection has been disconnected, wherein the second communication information is different from the first communication information; receive the identification information from the second communication device after the first wireless connection has been disconnected; and in a case where the second communication information is obtained and the identification information is received, delete, from the memory, the first communication information which is associated with the identification information and store, in the memory, the second communication information in association with the identification information.

According to the above configuration, the first communication device acquires the variable first communication information in order to establish the first wireless connection between the first communication device and the second communication device, receives the fixed identification information from the second communication device, and stores these information in association with each other. Thereafter, after the first wireless communication has been disconnected, the first communication device acquires the variable second communication information for establishing the second wireless connection between the first and second communication devices, and receives the identification information from the second communication device. In this case, the first communication device deletes the first communication information that is associated with the identification information, and stores the second communication information in association with the identification information. Since the first communication information is not kept in the memory, load on the memory can be reduced.

A non-transitory computer-readable recording medium storing computer-readable instructions for the above-described first communication device and a method executed by the first communication device are also novel and useful.

### BRIEF DESCRIPTION OF DRAWINGS

FIG. 1 illustrates a configurational diagram of a communication system.

FIG. 2 is a sequence diagram of processes executed between respective devices.

FIG. 3 is a sequence diagram which is continued from FIG. 2.

### DESCRIPTION

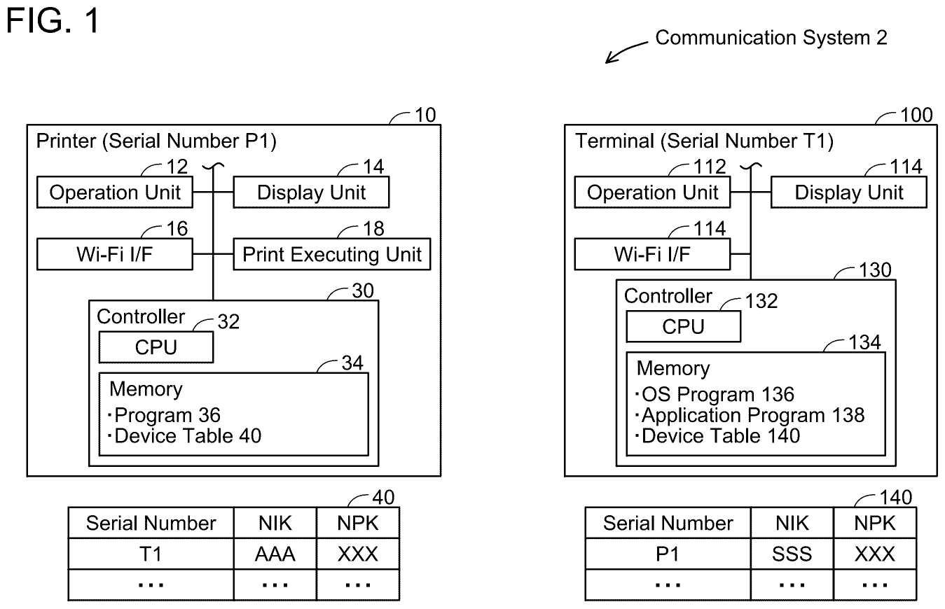

### Configuration of Communication System; FIG. 1

As illustrated in FIG. 1, a communication system 2 comprises a printer 10 and a terminal 100. In the present embodiment, a situation where wireless connection according to Wi-Fi Aware scheme of a Wi-Fi standard (hereafter, called “Wi-Fi Aware connection”) is established between the printer 10 and the terminal 100 will be assumed.

### Configuration of Printer 10

The printer 10 is a peripheral device configured to execute a print function, for example, a peripheral device of the terminal 100. In a modification, the printer 10 may be a multifunctional device configured to execute a scan function, a facsimile function, and the like in addition to a print function. The printer 10 comprises an operation unit 12, a display unit 14, a Wi-Fi interface 16, a print executing unit 18, and a controller 30. The units 12 to 30 are connected to a bus line. Hereinafter, an interface is abbreviated as “I/F”.

The operation unit 12 is an I/F configured to allow a user to input various information to the printer 10 and comprises, for example, a touch screen and/or buttons. The user can input various information to the printer 10 via the operation unit 12. The display unit 14 is a display for displaying various information. The print executing unit 18 comprises a print mechanism of, for example, inkjet scheme, laser scheme, or thermal scheme.

The Wi-Fi I/F 16 is a wireless I/F for Wi-Fi communication according to the Wi-Fi standard. The Wi-Fi standard is a wireless communication standard for wireless communication according to, for example, 802.11 standard of the Institute of Electrical and Electronics Engineers, Inc. (IEEE) and standards in compliance therewith such as 802.11a, 11b, 11g, 11n, and 11ac. Especially, the Wi-Fi I/F 16 supports the Wi-Fi Aware scheme established by the Wi-Fi Alliance. The Wi-Fi Aware scheme is described in detail in the specification called “Wi-Fi Aware Specification Version 4.0” created by the Wi-Fi Alliance. Wi-Fi Aware is also called Wi-Fi Neighbor Awareness Network (NAN).

The devices (the printer 10 and the terminal 100) can join a NAN cluster of the Wi-Fi Aware scheme, although details will be described later. Among devices within the same NAN cluster, their Discovery Windows are synchronized. Here, a Discovery Window is a period during which signals are communicated.

The devices within the NAN cluster play any one of roles called Master, Anchor Master, and Non-Master. A Master is capable of sharing timer information, searching for services, and inviting a device to the NAN cluster. In addition to the Master's functions, an Anchor Master is also capable of setting timer information for synchronization. A Non-Master is capable of sharing timer information and searching for services but incapable of inviting a device to the cluster.

Each device within the NAN cluster can search for another device within the NAN cluster (more specifically, service which the other device provides). A signal for searching for a service is called ‘Subscribe’. The device having received the Subscribe sends a response signal called ‘Publish’. Although details will be described later, in the present embodiment, the terminal 100 sends the Subscribe for searching for another device which is capable of providing a connection service related to Wi-Fi Aware connection. Since the printer 10 is capable of providing the connection service, the printer 10 sends the Publish indicating that the printer 10 is capable of providing the connection service to the terminal 100. As a result of this, when a process for establishing Wi-Fi Aware connection between the printer 10 and the terminal 100 is executed, Wi-Fi Aware connection is established.

The controller 30 comprises a CPU 32 and a memory 34. The memory 34 comprises a primary storage and an auxiliary storage. The primary storage comprises, for example, a RAM and cache memory. The auxiliary storage may be, for example, a flash memory, a Solid State Drive (SSD) or a ROM, or a combination thereof. A program 36 is stored in the auxiliary storage. The CPU 32 executes respective processes in accordance with the program 36 loaded from the auxiliary storage to the primary storage.

The memory 34 further stores a device table 40. The device table 40 is a table for storing information related to device(s) which have the Wi-Fi Aware connection established with the printer 10 (i.e., device with which pairing has been done). The device table 40 stores a serial number of the device which has the Wi-Fi Aware connection established with the printer 10, NAN Identity Key (NIK) of the device, and NAN Pairing Key (NPK) shared with the device, in association with each other. The serial number is a number assigned by a vendor of the device, and is unique, fixed information. Contrary to this, the NIK and NPK are information for establishing the Wi-Fi Aware connection between the printer 10 and the device, and are variable information. More specifically, the NIK is device identification information in the Wi-Fi Aware scheme. Since an expiry date is set for the NIK, and thus the NIK is changed in response to lapse of the expiry date. Also, the NPK is key information used for encryption in the Wi-Fi Aware connection. The NPK is changed each time the Wi-Fi Aware connection is established.

### Configuration of Terminal 100

The terminal 100 is a mobile terminal device such as a mobile phone, a smartphone, a PDA, a tablet PC, or the like. In a modification, the terminal 100 may be a stationary PC, a laptop PC, or the like. The terminal 100 comprises an operation unit 112, a display unit 114, a Wi-Fi I/F 116, and a controller 130. The units 112 to 130 are connected to a bus line.

The operation unit 112 is an I/F configured to allow the user to input various information to the terminal 100, and comprises, for example, a touch screen and/or buttons. The user can input various information to the terminal 100 via the operation unit 112. The display unit 114 is a display for displaying various information. The Wi-Fi I/F 116 is the same as the Wi-Fi I/F 16 of the printer 10. That is, the Wi-Fi I/F 116 supports the Wi-Fi Aware scheme.

The controller 130 comprises a CPU 132 and a memory 134. The memory 134 comprises a main storage and an auxiliary storage. The main storage comprises for example a RAM, a cache memory, etc. The auxiliary storage may be, for example, a flash memory, a Solid State Drive (SSD), a ROM, or any combination thereof. An OS program 136 and an application program 138 are stored in the auxiliary storage. The CPU 132 implements various processes according to the programs 136, 138 loaded from the auxiliary storage to the main storage. Hereinafter, an OS program is abbreviated as “OS” and the application program is abbreviated as “app”.

The OS 136 controls basic operations of the terminal 100. The app 138 can cause the OS 136 to execute a process according to the Wi-Fi Aware scheme to establish the Wi-Fi Aware connection between the printer 10 and the terminal 100. Also, the app 138 can send print data representing an image to be printed to the printer 10 by using such Wi-Fi Aware connection. The app 138 is downloaded, for example, from a server on the internet and installed in the terminal 100.

The memory 134 further stores a device table 140. Similar to the device table 40 stored in the memory 34 of the printer 10, the device table 140 stores a serial number of a device which has the Wi-Fi Aware connection established with the terminal 100, an NIK of the device, and an NPK shared by the device, in association with each other.

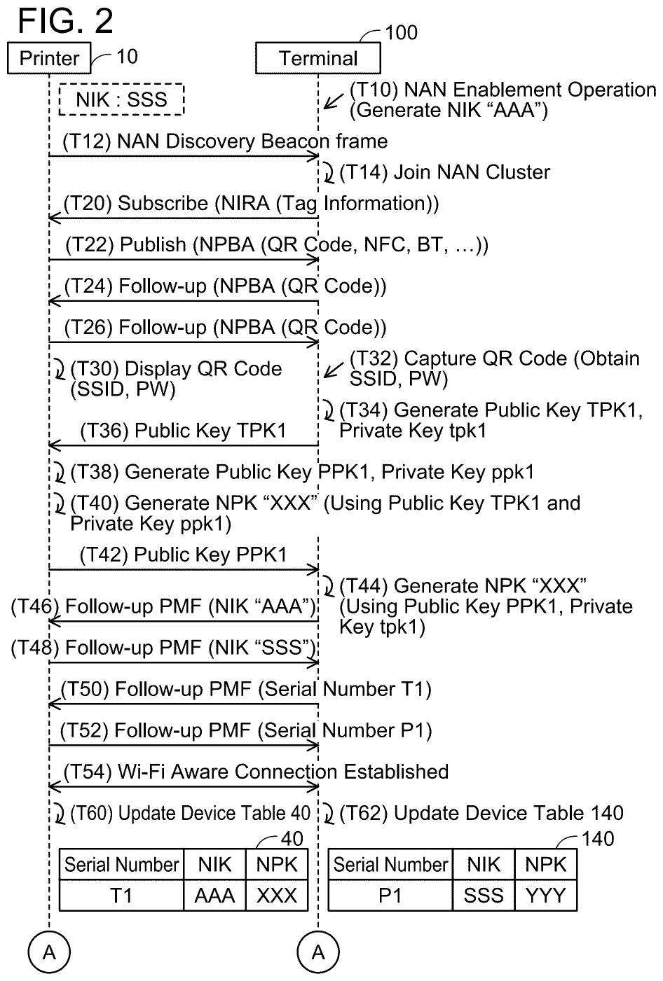

### Processes Executed Between Respective Devices; FIG. 2

Referring now to FIG. 2, steps performed between the devices are described. Hereafter, in order to facilitate understanding, steps performed by the CPUs (e.g., 32, 132) of the device (e.g., the printer 10, the terminal 100) are described as if devices perform the steps, instead of describing that the CPUs perform the steps. Every communication between the devices is executed via the Wi-Fi I/Fs (e.g., 16, 116). Thus, hereinafter, a phrase “via the Wi-Fi I/F” is omitted in communication-related description.

In an initial state of FIG. 2, the printer 10 belongs to a NAN cluster, and operates as Anchor Master. In particular, the printer 10 stores an NIK “SSS” of the printer 10.

When the terminal 100 receives a NAN enablement operation from the user in T10, the terminal 100 shifts to a state of being able to receive a signal according to the Wi-Fi Aware scheme, and generates an NIK “AAA” of the terminal 100. Here, the “state of being able to receive a signal according to the Wi-Fi Aware scheme” means that the Wi-Fi I/F 116 can receive signals according to the Wi-Fi Aware scheme from external devices and the CPU 132 can perform steps according to the received signal.

In T12, the printer 10 sends a NAN Discovery Beacon frame (termed “Discovery” hereinafter) by broadcasting. The Discovery is a signal according to the Wi-Fi Aware scheme that advises information related to the NAN cluster to which the printer 10 belongs to external devices. Devices that do not belong to the NAN cluster can join the NAN cluster by receiving the Discovery. That is, the Discovery can be also construed as a signal for inviting devices that do not belong to the NAN cluster to the NAN cluster. The printer 10 periodically sends a Discovery.

At the time of T12, the terminal 100 is in the state of being able to receive signals according to the Wi-Fi Aware scheme. Thus, the terminal 100 receives the Discovery from the printer 10 in T12. In response, the terminal 100 joins the NAN cluster in T14. As a result, the printer 10 and the terminal 100 belong to the same NAN cluster. Although not illustrated, after joining the NAN cluster, the terminal 100 communicates with the printer 10 to determine its role in the NAN cluster. In the present case, the terminal 100 operates as a Non-Master.

In T20, the terminal 100 sends the Subscribe to the NAN cluster by broadcasting. The Subscribe is sent when a predetermined trigger (e.g., new participation in a NAN cluster, arrival of a predetermined timing, acceptance of a predetermined operation) occurs. In the present case, this Subscribe is sent to the printer 10 within the NAN cluster. This Subscribe of the present case is a signal for searching a device which provides a connection service, i.e., a signal for searching a device being able to establish the Wi-Fi Aware connection. This Subscribe includes ‘NAN Identity Resolution Attribute (NIRA)’. Also, NIRA includes Tag information. The Tag information includes a hash value for the NIK “AAA” of the terminal 100. Here, although not described in particular in the present embodiment, the printer 10 may send a Subscribe.

When the printer 10 receives the Subscribe from the terminal 100 in T20, the printer 10 determines whether the printer 10 has executed the pairing with the terminal 100 being the sender of the Subscribe. Specifically, the printer 10 specifies the one NIK included in the device table 40. Then, the printer 10 calculates a hash value for the specified NIK. When the calculated hash value and the hash value received in T20 match, the printer 10 determines that the printer 10 has executed the pairing with the terminal 100. Contrary to this, when the calculated hash value and the hash value received in T20 do not match, the printer 10 specifies another NIK included in the device table 40 and executes the same process as above for this other NIK. When the hash value of such NIK and the hash value received in T20 do not match for each of all the NIKs included in the device table 40, the printer 10 determines that the printer 10 has not executed the pairing with the terminal 100. Also, when no NIK is included in the device table 40, the printer 10 determines that the printer 10 has not executed the pairing with the terminal 100.

In the present case, at the time of T20, no NIK is stored in the device table 40. Accordingly, the printer 10 determines that the printer 10 has not executed the pairing with the terminal 100, and in T22 the printer 10 sends a Publish including NAN Pairing Bootstrapping Attribute (NPBA) to the terminal 100. The NPBA includes information indicating method(s) for Bootstrapping which the printer 10 supports. In the present case, the printer 10 supports at least QR Code, Near Field Communication (NFC), and Bluetooth (BT) as methods for Bootstrapping. Accordingly, the Publish sent in T22 includes information indicating QR Code, information indicating NFC, and information indicating BT. Here, QR Code is a registered trademark of Denso Wave Incorporated. Bluetooth is a registered trademark of Bluetooth SIG.

In T22, the terminal 100 receives the Publish including NPBA from the printer 10. In this case, the terminal 100 specifies a Bootstrapping method which the terminal 100 supports from the respective Bootstrapping methods indicated by the received NPBA. In the present case, the terminal 100 comprises an unillustrated camera, but does not comprise an NFC I/F or a BT I/F. That is, the terminal 100 in the present case supports Bootstrapping by way of capturing QR Code, but does not support Bootstrapping by ways of NFC, BT. Due to this, in T24, the terminal 100 sends Follow-up including the NPBA to the printer 10. Such Follow-up includes information indicating that the terminal 100 supports QR Code. Follow-up is a signal defined by the Wi-Fi Aware scheme.

When the printer 10 receives the Follow-up from the terminal 100 in T24, the printer 10 sends Follow-up including the NPBA to the terminal 100 in T26. Such NPBA includes information indicating that the printer 10 is to execute Bootstrapping by QR Code. Then, in T30, the printer 10 displays QR Code on the display unit 14. Such QR Code can be obtained by coding a Service Set Identifier (SSID) and a password (hereafter, “PW”). The SSID and PW are authentication information used for executing Pre-Association Security Negotiation (PASN). The PASN is a process of exchanging key information such as a public key between the printer 10 and the terminal 100, and is executed with the same method as WPA3-SAE.

In T26, the terminal 100 receives the Follow-up from the printer 10. In this case, although not illustrated, the terminal 100 may display a message notifying that QR Code displayed on the printer 10 should be captured, on the display unit 114. In T32, a user of the terminal 100 may capture the displayed QR Code on the printer 10 by using the camera of the terminal 100. In this case, the terminal 100 obtains the SSID and PW by decoding the captured QR Code. The terminal 100 can execute PASN with the printer 10 by using the obtained SSID and PW.

In T34, the terminal 100 generates a public key TPK1 and a private key tpk1 of the terminal 100. The public key TPK1 and the private key tpk1 are information used for generating NPK. When the terminal 100 has generated the public key TPK1 and the private key tpk1, the terminal 100 sends the public key TPK1 to the printer 10 in T36.

When the printer 10 receives the public key TPK1 from the terminal 100 in T36, the printer 10 generates a public key PPK1 and a private key ppk1 of the printer 10 in T38. The public key PPK1 and the private key ppk1 are information used for generating NPK. When the printer 10 has generated the public key PPK1 and the private key ppk1, the printer 10 generates NPK “XXX” by using the received public key TPK1 of the terminal 100 and the generated private key ppk1 of the printer 10 in T40. In T42, the printer 10 sends the public key PPK1 to the terminal 100.

When the terminal 100 receives the public key PPK1 from the printer 10 in T42, the terminal 100 generates the NPK “XXX” by using the received public key PPK1 of the printer 10 and the generated private key tpk1 of the terminal 100 in T44. The NPK “XXX” generated here and the NPK “XXX” generated by the printer 10 in T40 are the same. That is, the NPK “XXX” is shared between the printer 10 and the terminal 100.

Next, in T46, the terminal 100 sends ‘Follow-up Protected Management Frame (PMF)’ including the NIK “AAA” of the terminal 100 to the printer 10. Here, the “Follow-up PMF” means executing Follow-up communication by using a communication path which is encrypted by NPK. That is, Follow-up of T46 is sent from the terminal 100 to the printer 10 by using the communication path encrypted by the NPK “XXX”.

In T46, the printer 10 receives Follow-up PMF including the NIK “AAA” of the terminal 100 from the terminal 100. In T48, the printer 10 then sends Follow-up PMF including the NIK “SSS” of the printer 10 to the terminal 100.

In T48, the terminal 100 receives the Follow-up PMF including the NIK “SSS” of the printer 10 from the printer 10. Then, in T50, the terminal 100 sends Follow-up PMF including a serial number T1 of the terminal 100 to the printer 10.

In T50, the printer 10 receives the Follow-up PMF including the serial number T1 of the terminal 100 from the terminal 100. As such, the printer 10 receives the serial number T1 during a series of processes for establishing the Wi-Fi Aware connection. That is, the printer 10 can receive the serial number T1 of the terminal 100 relatively quickly. Then, in T52, the printer 10 sends Follow-up PMF including a serial number P1 of the printer 10 to the terminal 100.

In T52, the terminal 100 receives the Follow-up PMF including the serial number P1 of the printer 10 from the printer 10.

By the above processes, the printer 10 obtains the NPK “XXX” and the NIK “AAA” of the terminal 100. Also, the terminal 100 obtains the NPK “XXX” and the NIK “SSS” of the printer 10. As mentioned above, an NPK and an NIK are information for establishing the Wi-Fi Aware connection. Accordingly, in T54, respective processes in which the NPK, NIK or the like are used are executed between the printer 10 and the terminal 100, and the Wi-Fi Aware connection is established between the printer 10 and the terminal 100 (i.e., the printer 10 and the terminal 100 enter a state of having executed the pairing).

Also, in T60, the printer 10 updates the device table 40. Specifically, the printer 10 determines whether the serial number T1 received in T50 is stored in the device table 40 or not. In the present case, since the serial number T1 is not stored in the device table 40, the printer 10 stores the serial number T1 received in T50, the NIK “AAA” received in T46, and the NPK “XXX” generated in T40 in association with each other in the device table 40.

In T62, the terminal 100 updates the device table 140. Specifically, firstly, the terminal 100 determines whether the serial number P1 received in T52 is stored in the device table 140 or not. In the present case, since the serial number P1 is not stored in the device table 140, the terminal 100 stores the serial number P1 received in T52, the NIK “SSS” received in T48, and the NPK “XXX” generated in T44 in association with each other in the device table 140. As such, in each of the printer 10 and the terminal 100, the respective information for establishing the Wi-Fi Aware connection (see T54) between the printer 10 and the terminal 100 is stored.

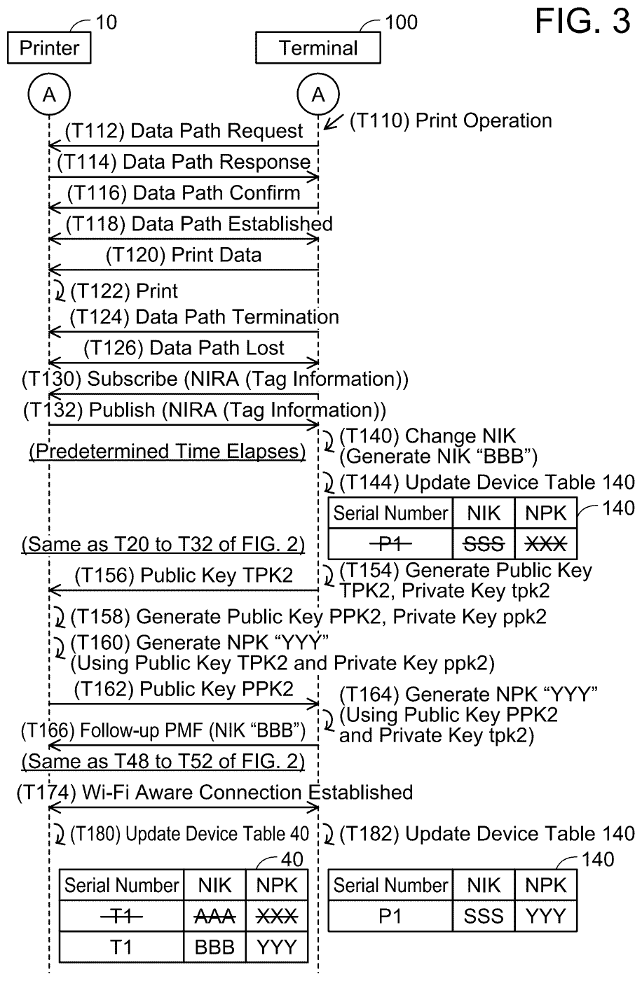

### Continuation of FIG. 2; FIG. 3

Thereafter, in T110 of FIG. 3, the terminal 100 receives a print operation for causing the printer 10 to print an image to be printed from the user. Such print operation includes, for example, designation of image data representing the image to be printed, designation of a printer to be caused to print, and/or setting on print condition(s) (e.g., print paper size, number of sheets to be printed, number of colors (color, monochrome, grayscale)). In this case, in T112, the terminal 100 sends a Data Path Request to the printer 10. The Data Path Request is a signal which requests the printer 10 to establish a communication path (i.e., Data Path) for communication of print data within the established Wi-Fi Aware connection (see T54 of FIG. 2).

When the printer 10 receives the Data Path Request from the terminal 100 in T112, the printer 10 sends a Data Path Response to the terminal 100 in T114.

When the terminal 100 receives the Data Path Response from the printer 10 in T114, the terminal 100 sends a Data Path Confirm to the printer 10 in T116. As a result of this, in T118 a Data Path is established within the Wi-Fi Aware connection between the printer 10 and the terminal 100. Then, in T120, the terminal 100 sends the print data representing the image to be printed by using the Data Path to the printer 10. The print data has a data format which the printer 10 can interpret.

When the printer 10 receives the print data from the terminal 100 in T120, the printer 10 causes the print executing unit 18 to print the image to be printed represented by such image data in T122.

When the terminal 100 has completed sending the print data in T120, the terminal 100 sends a Data Path Termination to the printer 10 in T124. As a result of this, in T126 the Data Path between the printer 10 and the terminal 100 disappears.

Thereafter, in T130 the terminal 100 sends the Subscribe to the printer 10 in response to an occurrence of a predetermined trigger. The process of T130 is the same as the process of T20 of FIG. 2.

When the printer 10 receives the Subscribe from the terminal 100 in T130, the printer 10 determines whether the printer 10 has executed the pairing with the terminal 100, the sender of the Subscribe or not. The specific method on how the printer 10 performs the determination is already discussed above. In the present case, at the time of T130, one NIK “AAA” is stored in the device table 40 (see T60 of FIG. 2). The printer 10 specifies the one NIK “AAA” from the device table 40, and calculates a hash value of the one NIK “AAA”. The calculated hash value and the hash value received in T130 match. Accordingly, the printer 10 determines that the printer 10 has executed the pairing with the terminal 100. In this case, in T132, the printer 10 sends a Publish to the terminal 100. Such Publish includes NIRA. Also, such NIRA includes the Tag information including a hash value of the NIK “SSS” of the printer 10.

When the terminal 100 receives the Publish from the printer 10 in T132, the terminal 100 determines whether the terminal 100 has executed the pairing with the printer 10, the sender of the Publish, or not. In the present case, at the time of T132, one NIK “SSS” (see T62 of FIG. 2) is stored in the device table 140. The terminal 100 specifies the one NIK “SSS” from the device table 140, and calculates a hash value of the one NIK “SSS”. The calculated hash value and the hash value received in T130 match. Accordingly, the terminal 100 determines that the terminal 100 has executed the pairing with the printer 10.

As described above, an expiry date is set for an NIK. A situation where, after the process of T132, the expiry date of the NIK “AAA” of the terminal 100 lapses due to a predetermined time having passed will be assumed. In this case, in T140, the terminal 100 generates a new NIK “BBB” of the terminal 100. As mentioned above, the NIK of the terminal 100 is information used for establishing (i.e., maintaining) the Wi-Fi Aware connection with the terminal 100, and is stored by a counterpart device (e.g., the printer 10) with which the terminal 100 has the Wi-Fi Aware connection established (see T60 of FIG. 2). Due to this, if the NIK of the terminal 100 is changed, the Wi-Fi Aware connection (see T54 of FIG. 2) that has been established between the printer 10 and the terminal 100 enters a state of being disconnected (i.e., the printer 10 and the terminal 100 enter a state of not having executed the pairing). In T144, the terminal 100 updates the device table 140. Specifically, the terminal 100 deletes the respective information stored in the device table 140. As mentioned above, this is because, since the established Wi-Fi Aware connection enters the disconnected state due to the change of the NIK, the respective information stored in the device table 140 become unnecessary.

Thereafter, the terminal 100 sends the Subscribe to the printer 10 in response to an occurrence of a predetermined trigger (see T20 of FIG. 2). At this time, since the Wi-Fi Aware connection is not established between the printer 10 and the terminal 100 (i.e., the printer 10 and the terminal 100 have not executed the pairing), processes that are the same as T20 to T32 of FIG. 2 are executed. Processes of T154 to T166 are the same as T34 to T46 of FIG. 2 except that the used information (i.e., public key, private key, NPK, and NIK) differs. Thereafter, processes that are the same as T48 to T52 of FIG. 2 are executed, and in T174, the Wi-Fi Aware connection is established between the printer 10 and the terminal 100.

In T180, the printer 10 updates the device table 40. Specifically, firstly, the printer 10 determines whether the serial number T1 received in T50 of FIG. 2, which is mentioned in FIG. 3, is stored in the device table 40 or not. In the present case, such serial number T1 is stored in a second row of the device table 40. In this case, the printer 10 deletes the respective information stored in the second row of the device table 40 (i.e., the serial number T1, the NIK “AAA”, and the NPK “XXX”) from the device table 40. Next, the printer 10 stores the serial number T1 received in T50 of FIG. 2, which is mentioned in FIG. 3, the NIK “BBB” received in T166, and the NPK “YYY” generated in T160 in association with each other in the device table 40 (see a third row of the device table 40 in FIG. 3). Here, in a modification, in T180, the printer 10 may not delete all the information in the second row of the device table 40, but store the NIK “BBB”, NPK “YYY” instead of the NIK “AAA”, the NPK “XXX” of the second row (i.e., may update the information in the second row of the device table 40).

Also, in T182, the terminal 100 updates the device table 140. Specifically, the terminal 100 firstly determines whether the serial number P1 received in T52 of FIG. 2, which is mentioned in FIG. 3, is stored in the device table 140 or not. In the present case, since the serial number P1 is not stored in the device table 140 (see T144), the terminal 100 stores the serial number P1 received in T52 of FIG. 2, which is mentioned in FIG. 3, the NIK “SSS” received in T48 of FIG. 2, which is mentioned in FIG. 3, and the NPK “YYY” generated in T164 in association with each other in the device table 140. As such, in each of the printer 10 and the terminal 100, the respective information for newly establishing the Wi-Fi Aware connection (see T174) between the printer 10 and the terminal 100 is stored.

### Effects of Embodiment

According to the above configuration, the printer 10 obtains the NIK “AAA” and the NPK “XXX” (see T40, T46 of FIG. 2) in order to establish the Wi-Fi Aware connection between the printer 10 and the terminal 100, receives the serial number T1 from the terminal 100 (T50), and stores these in association with each other in the device table 40 (T60). Thereafter, after the Wi-Fi Aware connection established in T54 of FIG. 2 has been disconnected (see T140 of FIG. 3), the printer 10 obtains the NIK “BBB” and the NPK “YYY” for establishing the new Wi-Fi Aware connection between the printer 10 and the terminal 100 (see T160, T166 of FIG. 3), and receives the serial number T1 from the terminal 100 (see T50 of FIG. 2 which is mentioned in FIG. 3). In this case, the printer 10 deletes the NIK “AAA” and the NPK “XXX” that are stored in the device table 40 and associated with the serial number T1, and stores the NIK “BBB” and the NPK “YYY” in association with the serial number T1 (T180). When the serial number T1 is received and an NIK and an NPK that are different from the NIK and NPK stored in association with the serial number T1 are obtained under a situation where the serial number T1 is stored in the device table 40, a new Wi-Fi Aware connection is established between the printer 10 and the terminal 100, and the old Wi-Fi Aware connection is disconnected. That is, under the situation as mentioned above, the NIK “AAA” and the NPK “XXX” are unnecessary information. Since such unnecessary information is not kept in the memory 34, load on the memory 34 can be reduced.

Also, when the printer 10 receives the Subscribe including the Tag information from the terminal 100, the printer 10 executes the process of specifying one NIK in the device table 40, calculates a hash value of that one NIK, and compares the same with the hash value stored in the Tag information. If unnecessary information is kept in the device table 40, the process of comparison as mentioned above would be executed on the unnecessary information also, which would result in an increase in processing load of the printer 10. Contrary to this, in the present embodiment, because unnecessary information is not kept in the device table 40 of the memory 34, the processing load of the printer 10 can be reduced.

### Correspondence Relationships

The printer 10 and the terminal 100 are an example for “first communication device” and “second communication device”, respectively. The Wi-Fi Aware connection established in T54 of FIG. 2 and the Wi-Fi Aware connection established in T174 of FIG. 3 are an example for “first wireless connection” and “second wireless connection”, respectively. The NIK “AAA” and the NPK “XXX” are an example for “first communication information”. In particular, the NIK “AAA” is an example for “first variable identification information” and “first NIK”. The NPK “XXX” is an example for “first key information” and “first NPK”. The NIK “BBB” and the NPK “YYY” are an example for “second communication information”. In particular, the NIK “BBB” is an example for “second variable identification information” and “second NIK”. The NPK “YYY” is an example for “second key information” and “second NPK”. The serial number T1 of the terminal 100 is an example for “identification information”.

The processes of T40 and T46 of FIG. 2 are an example for “obtain variable first communication information”. The process of T50 is an example for “receive fixed identification information of the second communication device from the second communication device”. The process of T60 is an example for “store, in the memory, the first communication information and the identification information in association with each other”. The processes of T160 and T166 of FIG. 3 are an example for “obtain variable second communication information”. The process of T50 of FIG. 2, which is mentioned in FIG. 3, is an example for “receive the identification information from the second communication device after the first wireless connection has been disconnected”. The process of T180 of FIG. 3 is an example for “delete, from the memory, the first communication information which is associated with the identification information and store, in the memory, the second communication information in association with the identification information”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
(Modification 1) In the above-described embodiment, an example where in the device table 40 of the printer 10, the NIK “AAA” and the NPK “XXX” are deleted and the new NIK “BBB” and the new NPK “YYY” are stored in response to the NIK of the terminal 100 being changed from the NIK “AAA” to the NIK “BBB” was described. As is the same as the above embodiment, a technology where the device table 140 of the terminal 100 is updated in response to the NIK of the printer 10 being changed is also useful. In the present modification, the terminal 100 and the printer 10 are an example for “first communication device” and “second communication device”.
(Modification 2) The printer 10 may store a MAC address, for example, instead of a serial number in the device table 40. The MAC address is also fixed information. In this case, in T50 of FIG. 2, the printer 10 may receive Follow-up PMF including a MAC address of the terminal 100. In the present modification, the MAC address is an example for “identification information”. In general terms, the “identification information” simply needs to be fixed information of the “second communication device”.
(Modification 3) In the above embodiment, the printer 10 receives the NIK “AAA”, the serial number T1, or the like from the terminal 100 by Follow-up (T46, T50 of FIG. 2). Instead of this, for example, the printer 10 may firstly establish a Data Path with the terminal 100, and use this Data Path to receive the serial number T1 or the like from the terminal 100, or may receive the serial number T1 or the like from the terminal 100 by Subscribe or Publish. In general terms, “receive fixed identification information of the second communication device from the second communication device (and receive the identification information from the second communication device after the first wireless connection has been disconnected)” may comprise receiving the identification information from the second communication device with a method different from the Follow-up.
(Modification 4) In the above embodiment, in response to the lapse of the expiry date of the NIK “AAA”, the NIK “AAA” is changed to the NIK “BBB”. In a modification, for example, when receiving a NAN disablement operation from a user, the NIK “AAA” may be deleted. Thereafter, when receiving the NAN enablement operation from the user again, a new NIK “BBB” may be generated. Also, in another modification, when receiving an operation of resetting setting of the terminal 100 from the user for example, the NIK “AAA” may be deleted and a new NIK “BBB” may be generated.
(Modification 5) In the above embodiment, an NIK and an NPK are utilized to establish the Wi-Fi Aware connection. In a modification, at least one of the NIK and the NPK may not be utilized, and information besides the NIK and NPK may further be utilized. In general terms, the “communication information” may not include at least one of the “key information” and “variable identification information”, and may include information besides the “key information” and “variable identification information”.
(Modification 6) Wireless connection established between the printer 10 and the terminal 100 may not be the Wi-Fi Aware connection (i.e., wireless connection according to the Wi-Fi Aware scheme).
(Modification 7) In the above embodiment, the processes of steps in FIGS. 2 and 3 are realized by software (e.g., the program 36, the OS 136, the app 138), but at least one of these processes may be realized by hardware such as a logic circuitry.

What is claimed is:

1. A first communication device comprising:
a memory; and
a controller,
wherein the controller is configured to:
obtain variable first communication information for establishing a first wireless connection between the first communication device and a second communication device;
receive fixed identification information of the second communication device from the second communication device;
in a case where the first communication information is obtained and the identification information is received, store, in the memory, the first communication information and the identification information in association with each other;
obtain variable second communication information for establishing a second wireless connection between the first communication device and the second communication device after the first wireless connection has been disconnected, wherein the second communication information is different from the first communication information;
receive the identification information from the second communication device after the first wireless connection has been disconnected; and
in a case where the second communication information is obtained and the identification information is received, delete, from the memory, the first communication information which is associated with the identification information and store, in the memory, the second communication information in association with the identification information.

2. The first communication device as in claim 1,
wherein the first communication information includes variable, first key information which is used for encryption in the first wireless connection, and
the second communication information includes variable, second key information which is used for encryption in the second wireless connection.

3. The first communication device as in claim 1,
wherein the first communication information includes first variable identification information which is variable identification information of the second communication device, and
the second communication information includes second variable identification information which is variable identification information of the second communication device.

4. The first communication device as in claim 1,
wherein each of the first wireless connection and the second wireless connection is a wireless connection according to a Wi-Fi Aware scheme of a Wi-Fi standard.

5. The first communication device as in claim 4,
wherein the first communication information includes a variable first NAN Pairing Key (NPK) which is used for encryption in the first wireless connection, wherein the NPK is defined according to the Wi-Fi Aware scheme, and
the second communication information includes a variable second NPK which is used for encryption in the second wireless connection.

6. The first communication device as in claim 4,
wherein the first communication information includes a first NAN Identify Key (NIK) which is variable identification information of the second communication device, wherein the NIK is defined according to the Wi-Fi Aware scheme, and
the second communication information includes a second NIK which is variable identification information of the second communication device.

7. The first communication device as in claim 4,
wherein the controller is configured to receive the identification information from the second communication device by Follow-up which is defined according to the Wi-Fi Aware scheme, and
the controller is configured to receive the identification information from the second communication device by the Follow-up after the first wireless connection has been disconnected.

8. A non-transitory computer-readable recording medium storing computer-readable instructions for a first communication device,
wherein the first communication device comprises:
a memory; and
a processor,
wherein the computer-readable instructions, when executed by the processor, cause the first communication device to:
obtain variable first communication information for establishing a first wireless connection between the first communication device and a second communication device;
receive fixed identification information of the second communication device from the second communication device;
in a case where the first communication information is obtained and the identification information is received, store, in the memory, the first communication information and the identification information in association with each other;
obtain variable second communication information for establishing a second wireless connection between the first communication device and the second communication device after the first wireless connection has been disconnected, wherein the second communication information is different from the first communication information;
receive the identification information from the second communication device after the first wireless connection has been disconnected; and
in a case where the second communication information is obtained and the identification information is received, delete, from the memory, the first communication information which is associated with the identification information and store, in the memory, the second communication information in association with the identification information.

9. A method executed by a first communication device,
wherein the first communication device comprises a memory,
the method comprising:
obtaining variable first communication information for establishing a first wireless connection between the first communication device and a second communication device;
receiving fixed identification information of the second communication device from the second communication device;
in a case where the first communication information is obtained and the identification information is received, storing, in the memory, the first communication information and the identification information in association with each other;
obtaining variable second communication information for establishing a second wireless connection between the first communication device and the second communication device after the first wireless connection has been disconnected, wherein the second communication information is different from the first communication information;
receiving the identification information from the second communication device after the first wireless connection has been disconnected; and
in a case where the second communication information is obtained and the identification information is received, deleting, from the memory, the first communication information which is associated with the identification information and storing, in the memory, the second communication information in association with the identification information.
